(19) United States
(12) Patent Application Publication
(10) Pub. No.: US 2008/0261735 A1
(43) Pub. Date: Oct. 23, 2008

(54) Transmission Case for Bicycles

(76) Inventor: Daniele Cappellini, Rome (IT)

Correspondence Address: YOUNG & THOMPSON, 209 Madison Street, Suite 500, ALEXANDRIA, VA, 22314, US

(21) Appl. No.: 11/816,303

(22) PCT Filed: Feb. 6, 2006
(86) PCT No.: PCT/IT06/00060

§ 371 Date: Aug. 15, 2007

(30) Foreign Application Priority Data
Feb. 16, 2005 (IT) RM2005A000065

(51) Int. Cl. F16H 9/00

(52) U.S. Cl. 474/78

(57) ABSTRACT

To change the transmission gear ratios of a bike and reduce its dimensions as much as possible. The derailleur, located between the two cog sets (2,3), is the latest, newest and a very important device. Both cog sets (2,3) have parallel and reversed rotating axles so that the big diameter cog (5), located on the primary cog set (2) corresponds to the small diameter cog (6), located on the secondary cog set (3). The primary cog set is assembled on the primary axle and is linked to the secondary cog set by a primary looping ring roller chain (8); the secondary cog set (3) supports the single external cog (15), linked to the rear wheel by the secondary chain (8). When the derailleur is externally activated, it shifts the primary chain (8) to the primary and the secondary cog sets (2,3), having different diameters, so as to change gear.

The Derailleur Case For Bicycles is a transmission system for bicycles, especially for off road performances and particularly to be used on mountain bikes. The aim of this invention is to reduce the transmission dimensions so as to insert all the components in a case or in the bicycle frame, to protect it from impurities and impacts. The principal components of The Derailleur Case For Bicycles is the primary cog set (2), the secondary cog set (3) and the derailleur (1). The suitably innovative derailleur is located between the primary and secondary cog sets and linked to a twist shifter (53) on the handlebar by means of a system of gear cables (45) and cable housing (46). When the biker operates on the twist shifter (53), the derailleur (1) moves sideways (A) on the proper upper and lower slide (37) (38) together with the primary looping ring roller chain (8), which moves on the cog sets, determining the gear ratio change and consequently the relative variation of revolutions between the rear wheel and the crankshaft. With the shifting (A) the primary roller chain (8) is always parallel to the longitudinal axis (64) of the bicycle and the derailleur (1) never touches the cog sets. The peculiar position of the cog sets enables the variation of revolutions during the chain shifting (A). The primary and secondary cog sets (2) (3) are assembled with the parallel rotation axis but on the other way around so that the big diameter cog of the primary cog set is on the left, and the small diameter cog of secondary cog set is on the same side. The primary cog set (2) is assembled on the primary axle (9) which the crank-arm (12) is fixed to and linked to the secondary cog set (3) by means of the primary roller chain (8). The secondary cog set (3) is assembled on the secondary axle (10) on the right side of which is fixed an outboard chain ring (15) outside the gear box, which, by means of a secondary roller chain (17) is linked to the cog (18) of the secondary transmission on the rear wheel hub. When the primary roller chain (8) is positioned between the single small diameter primary cog and the single big secondary cog, the speed is slower. When the chain is on the cogs with exactly the same diameter, positioned in the middle of the cog sets, the number of revolutions of the primary axle (9) and that that of the secondary axle (10) is the same. The fastest speed is obtained when the primary roller chain (8) is positioned on the primary big diameter cog of the primary cog set and the small diameter cog of the secondary cog set. The primary and the secondary cog sets (2) (3) have exactly the same numbers of cogs, thus, determining the numbers of gears. A floating derailleur pulley (22) and a couple of rollers, right and left, (30) (31) are the components of the derailleur that shift the chain. Two springs (23) are fixed on the hub (24) of the floating derailleur pulley (22) that runs on two slots in order to tighten the primary roller chain (8) and to compensate the difference of the cog diameters during gear changing. So the floating derailleur pulley (22) has a double function: to shift the primary roller chain (8), and to tighten it. When the floating derailleur pulley (22) moves the primary roller chain (8) to the left on the secondary cog set (3), a longer ratio gear is inserted; on the contrary, when the floating derailleur pulley is moved to the right, a shorter ratio gear is inserted. A non-floating derailleur pulley (19) of the derailleur (1) drives the primary roller chain (8) out of the primary cog set (2). The right and left side rollers (30) (31), on the lower part of the front derailleur (1), shift the primary roller chain onto the primary cog set (2). They rotate on two different axles (32) (33), the right side roller and the left side roller, so as to avoid any friction generated by the primary roller chain (8), that runs between them when the gears are changed. A longer ratio gear is inserted when The right side roller (30), pushes the primary roller chain (8) to the left; whereas, a shorter ratio gear is inserted when the left side roller (31) pushes the primary roller chain (8) to the right. The floating derailleur pulley (22), the right and the left side rollers (30) (31), being part of the derailleur (1), are always lined up to the bicycle axis (64) and the primary chain (8) moves sideways (A), when the gears are changed on the primary (2) and secondary (3) cog sets at the same time.

### TECHNICAL FIELD

In short, The Derailleur Case For Bicycles is composed of two cog sets assembled, on the other way around with a parallel rotation axle, but assembled in the opposite way so that the big diameter cog located on the primary cog set, corresponds to the small cog of the secondary cog set. The number of cogs for each cog set determines the numbers of the gears that are available. The peculiar derailleur runs on the cogs axles, enabling the roller chain of the primary transmission to shift sideways from the primary and secondary cog set and the gear changing, too and so, the variation of the rotations of the primary and secondary axles, where an outboard chain ring, is linked by a second chain to the cog of the rear wheel hub. This light and slightly smaller Derailleur Case For Bicycles has been specifically invented for its use on off road excursions, with its components closed in a boxed or a framed box, which is particularly suitable for all kinds of mountain bikes, where mud, dust and accidental impacts make the traditional parallelogram transmission systems extremely vulnerable. The Derailleur Case for Bicycles has the same ratio gears of a common mountain bike, with the outboard chain ring and the cog of the secondary transmission that can be freely personalized and used for all bike disciplines. The same bike can be used for downhill purposes, where it is necessary to have very long ratio gears compared to cross country, simply changing the cog on the secondary transmission hub. Furthermore, in downhill and free ride excursions, the rear tail has reached the same vibrations as those of motor-cycles, which, due to high speed, cause vibrations and to-and-fro movements, damaging its functionality and jeopardizing its durability. Thanks to the invention, mentioned above, the possibility of changing gears just by using a twist shifter positioned on the handlebar, it makes it easier for the everyday use of city bikes, too.

### BACKGROUND ART

The majority of transmission devices for bicycles on sale nowadays, are essentially of two kinds: the traditional front and rear parallelogram derailleur with their mechanism completely open and exposed; and the protected boxed gearing. The gearing devices are assembled on the hub between the rear cog set and the wheel, and it is possible to change gears through a cable that operates on the inner mechanism of the hub. The traditional devices, which are certainly most commonly diffused, are composed of two derailleurs, one in front, the other on the rear, that operate through cables linked to the twist shifters on the handlebar. Thanks to the derailleurs, the chain can move on the rear cog set of the rear hub, and on the ring gears of crank-arm, modifying the revolution rotation, thus obtaining the desired gear.

### DISCLOSURE OF THE INVENTION

The Derailleur Case for Bicycles is completely different from the traditional one because it does not include the same elements that characterize the traditional system, such as: the chain cage pivot, the front and the rear derailleurs for the cog set on rear wheel. Whereas, in the new invention, mentioned above, we have the gear changing inside a case, which protects all the components of the system from mud and accidental collisions. The case can be obtained by two parallel and longitudinal plates, one on the right (57), the other on the left (58), where the bearing housing, the axles holes, the frame supports and etc. . . . are located in. The devices in-between the two plates are closed in an easy removable plastic case that is divided into two parts (60) (61); a very small door (62), positioned on the lower part of the gear box, makes it easier to test and to lubrificate it. You can exploit the box by putting it in the bike frame assembling all the components into it, or, just by leaving its components exposed for no off road purposes. Externally, on the right side of the gear box, there is the secondary transmission composed of an outboard chain ring (15) and a secondary roller chain (17) linked to the rear cog (18) assembled on the rear wheel of the bike (63). The biker is completely free to choose the diameter and the numbers of teeth on the cogs of the secondary transmission, both to adjust the gear for the variety of its use so as to obtain the best performances of the bike. Changing gears generate a changing in the revolution between the primary axle (9) and the secondary axle (10) linked to the rear wheel through the secondary transmission, allowing the user to go up and down like a common mountain bike. The result of the percentage increase during the changing gears is always correct just by a twist shifter (53). So, it's not possible, as in the traditional bicycle system, to make any mistakes. In the above-mentioned invention, the gears are changed with only one twist shifter (53) on the handlebar, that operates on the derailleur (1), specifically realized for this purpose, which, moved sideways and running on the slides (37) (38), shifts the primary looping ring roller chain (8) between the primary (2) and secondary cog sets (3), oppositely set the parallel rotation axles. So, it is the particular position of the primary and secondary cog sets (2) (3) which renders it possible to obtain a revolution changing between the primary and secondary axles. The derailleur (1) has been projected to move the primary chain (8) on the primary and secondary cog sets at the same time. The components of the derailleur that shift the chain are: the floating derailleur pulley (22) that drives the chain on the secondary cog set (3), and a couple of rollers (30) (31) that drive the chain an the primary cog set (2). The floating pulley (22) tightens the primary chain with two springs (35), so it is possible to compensate the difference of the cogs' diameter during gears changing. A non-floating derailleur pulley (19) drives the chain out the primary cog set (2). The non-floating pulley is adjustable and it is possible to move it for a bit of millimetres on a small slot (21), compensating for the extension of the chain, due to its wear. The primary cog set (2) is assembled on the pedal axle called primary axle (9). The secondary cog set (3) derives its movement from the primary cog set (2) by means of the primary chain (8); the outboard chain (15) is assembled on the right side of its axle, called secondary axle (10). By means of the secondary chain (17), the outboard chain (15) activates the rear cog (18) of the secondary transmission assembled on the rear wheel hub of the bike (63). The primary and secondary cog sets have the same number of cogs, which is equivalent to the number of gears available. Thanks to its particular structure, The Derailleur Case For Bicycles allows a very quick changing of gears, compared to the traditional gear, because just with a twist shifter, the chain takes less time to move up and down the cogs. As far as the above mentioned invention is concerned, there is neither the front nor the rear derailleur as in traditional gears, which have to be synchronized by the biker to avoid the drop-out of the chain. Furthermore, with this system, the time employed for the chain to pass from the longer to the shorter gear ratio is shorter, because, thanks to the pulley, the primary chain does not shift from its housing and during gear changing, the two derailleur sliding blocks that drive it keep it in line with the cogs. At the same time, the derailleur in The Derailleur Case For Bicycles is an integrated device and independent from the other components as the primary and the secondary cog sets, and is linked to them just by means of the primary chain.

### BRIEF DESCRIPTION OF DRAWINGS

FIG. 1—The box of the Derailleur Case For Bicycle, as seen from the upper side when it is open, with the drawings of all its inner devices. The derailleur (1) that shifts to (A) is, and represented, on the left side of the longer gear ratio, the anti chain suck (54) device of the primary roller chain (8) is represented with a broken line. The bicycle axis (64), is also represented.

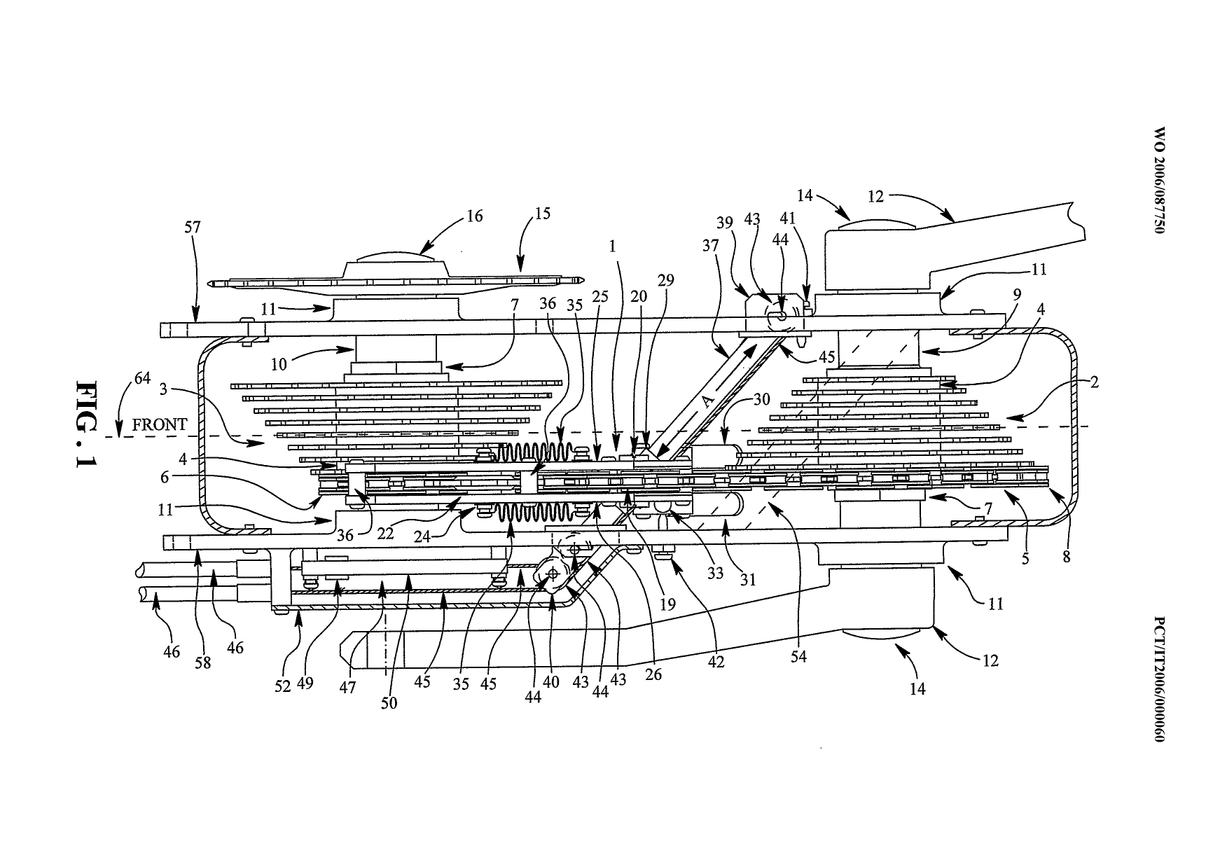

FIG. 2—The left side of The Derailleur Case For Bicycle, as seen when it is open with the drawings of all its inner components.

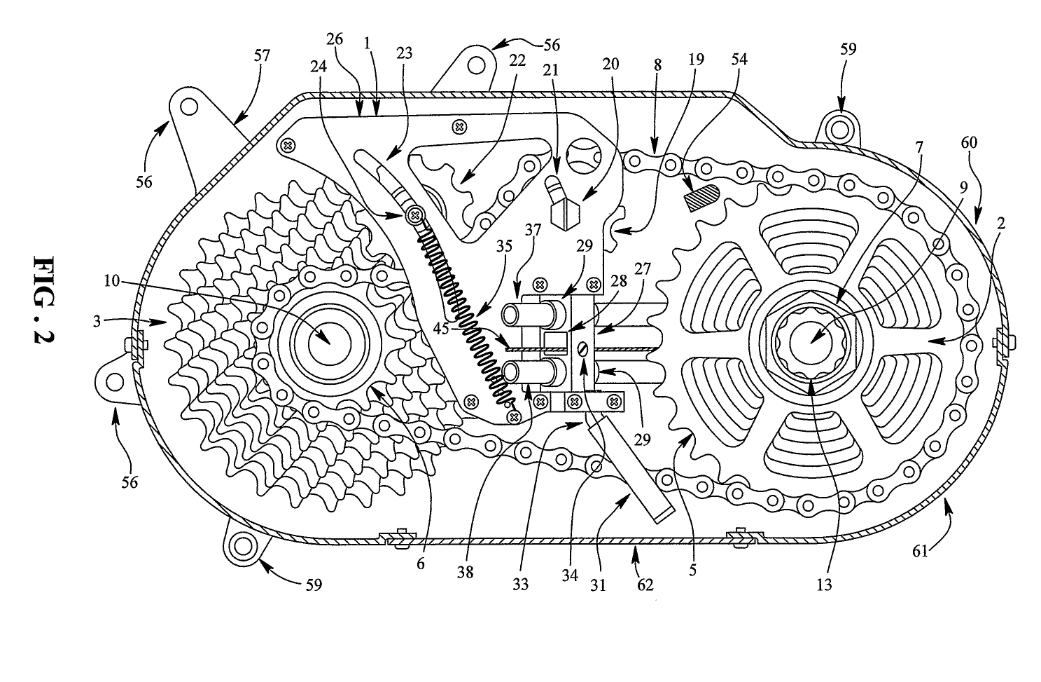

FIG. 3—The left side of The Derailleur Case For Bicycles, as seen when it is closed with the drawings of all its external elements. The components of the gear selector (47), the gear cable (45), the gear cable pulley (43) are pointed out. The crank-arm (12) is not drawn so as to point out the crank-arm spline (13) design on the primary axle (9) and the bearing (11).

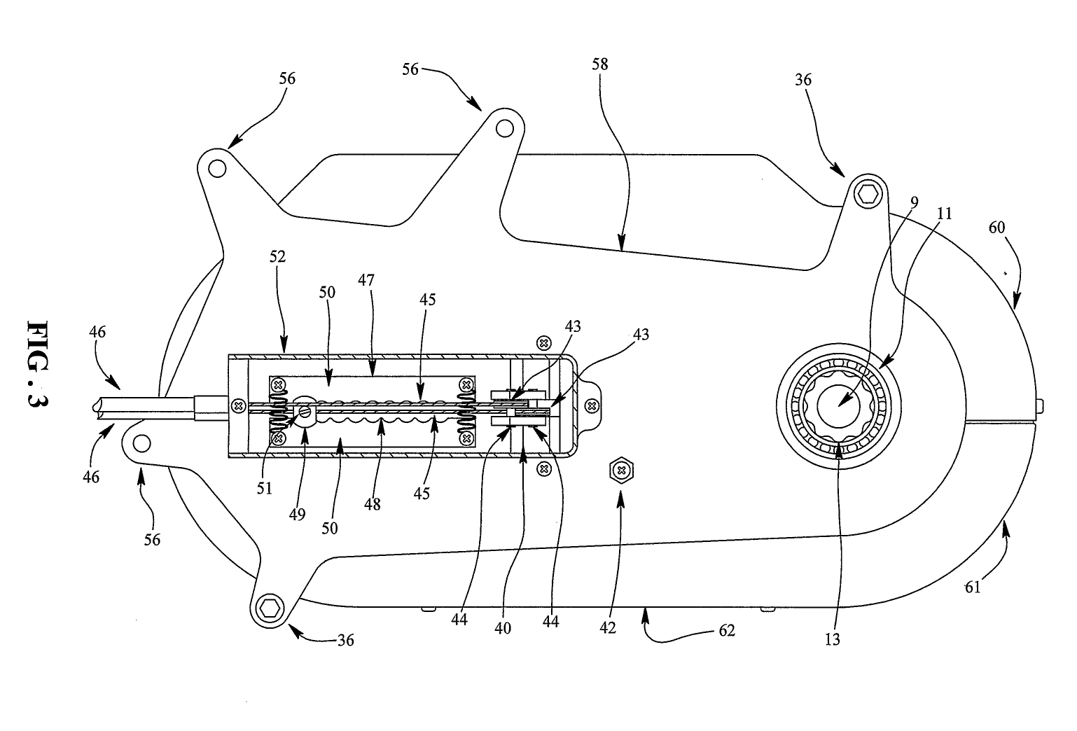

FIG. 4—Left side drawing of the derailleur (1) completed assembled and separated from the other elements.

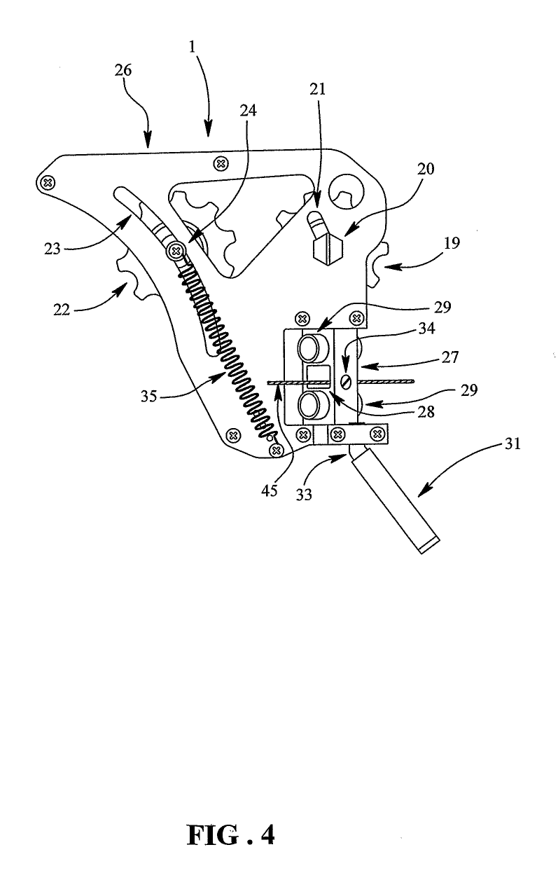

FIG. 5—Drawing of the right side of a bicycle (63), showing The Derailleur Case For Bicycles on a frame (55).

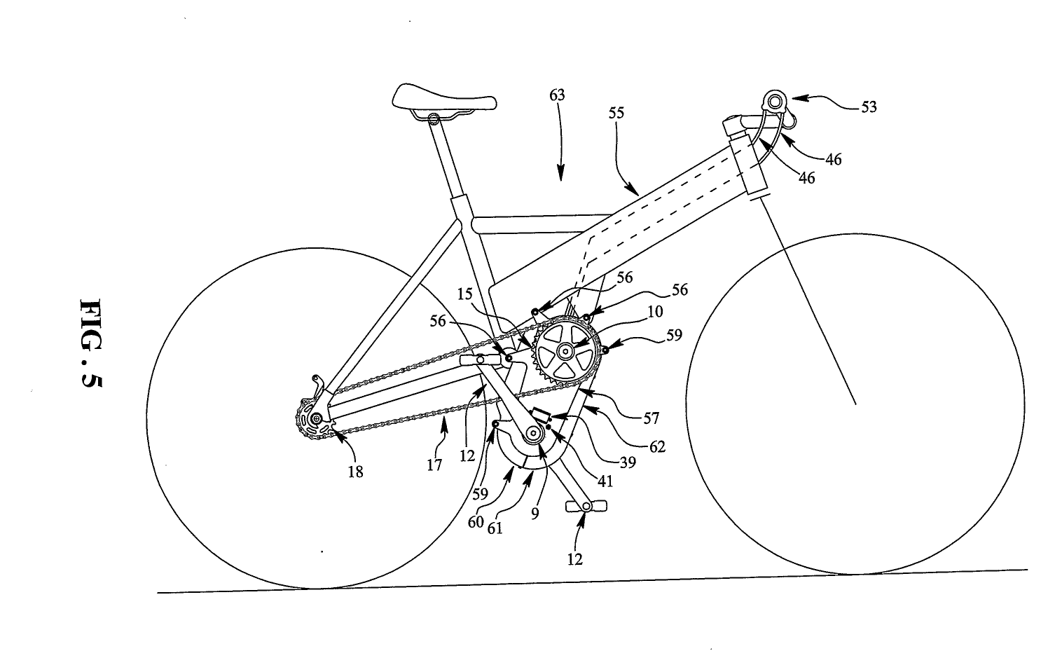

FIG. 6—Drawing of the left side of a bicycle (63)

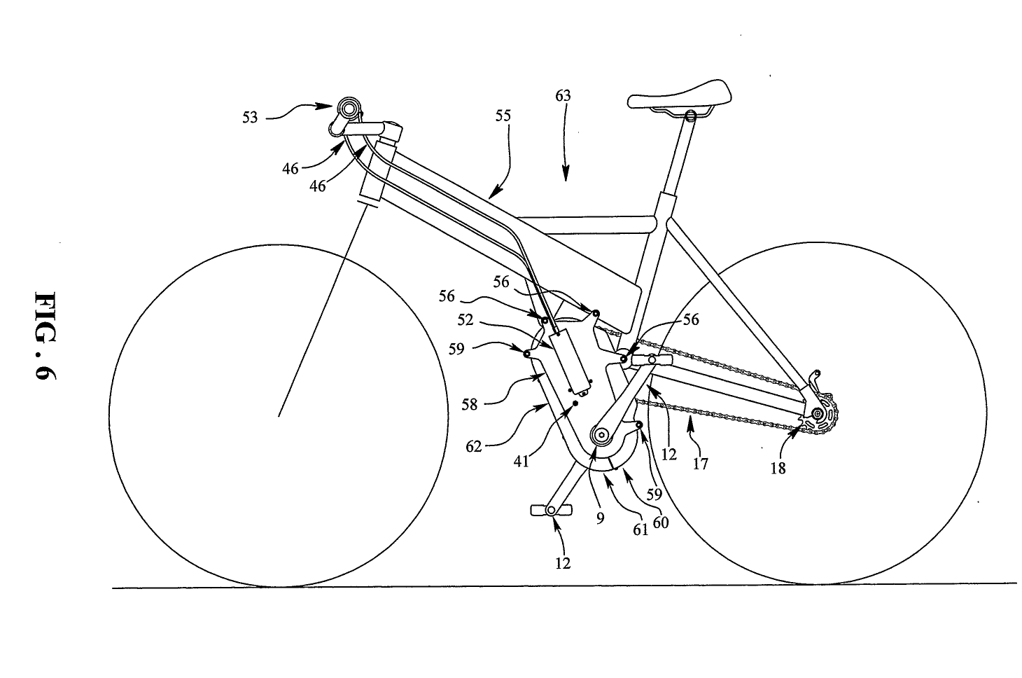

### BEST MODE FOR CARRYING OUT THE INVENTION

The invention is now described according to the inventor's favourite realization at the moment and is described just for illustrative purposes, and not strictly limited to, or restricted to the enclosed illustrations.

COG SETS. According to the above mentioned invention, the primary and secondary cog sets (2) (3) are composed of a series of interchangeable cogs with a progressive number of their teeth, ex.: 12-14-16 etc. . . . , that assembled in an increasing order and suitably spaced thanks to proper cog spacer (4), form a frustum of cone.

The primary and secondary cog sets are both assembled with the same numbers of cogs, determining the number of gears available. The gear change is obtainable for the peculiar position of the two cog sets, as regards to the position of the derailleur (1) that have their rotation primary cog set parallel but assembled on the other way around and much closer so that the big diameter left cog (5) corresponds to the small diameter left cog (6) located on the secondary cog set. All the cogs can be changed to have different useful gear ratios. The number of gears and the number of the cogs of each cog set can be personally adapted.

DERAILLEUR. The most innovative device of The Derailleur Case For Bicycles is the derailleur (1) that moving on (A), pushes a circular roller chain called primary looping ring roller chain (8) sideways, from the primary and secondary cog sets to the couple of cog sets on its side. The right (25) and left (26) side derailleur cages and the axles of the right (32) and left (33) side rollers are attached to the derailleur body (27), which is provided with two precision bushings (29) that let it run on the upper and lower slides (37) (38) made of two refaced steel tubes laid one on top of the other.

RIGHT AND LEFT SIDE ROLLERS. Totally agreeing with the present invention at the bottom of the rear part of the derailleur body (27), there are two steel axles (32) (33), that support the right and left side rollers (30) (31) which are almost in vertical position and parallel and shift the primary roller chain (8) sideways, implementing the changing of the gear ratio on the primary cog set (2). The rollers, rotating on the axles (32) (33) of the right and left side rollers, reduce the friction on the primary roller chain, running between them during the gear changing.

DERAILEUR CAGES. On the left and right side of the specular derailleur cages (25) (26) there are the slots (23) of the floating pulley (22) and the adjusting slots (21) of the non-floating derailleur pulley (19); the two pulleys, between the two cages, are separated with specific spacers (36) fixed on them. Outside the cages (25) (26), two chain tensioner springs are fixed. The derailleur body is fixed by holes on the cages.

NON-FLOATING DERAILLEUR PULLEY. According to the previous description, the non-floating derailleur pulley (19) drives the primary roller chain (8) out of the primary cog set (2), which is situated on the upper part of the derailleur between the cages, and is assembled between the primary cog set and the floating pulley. By means of the non-floating pulley, it is possible to adjust the tension of the primary chain moving it onto the proper slot (21) and fixing it after the adjustment with the pulley fixing bolt (20). Thanks to this, it is possible to compensate the natural stretch of the chain, due to its constant use.

FLOATING DERAILLEUR PULLEY. According to the description previously described, in the lower part of the derailleur, between the left and right cages (25) (26), there is the floating pulley (22) that moves the primary roller chain (8) sideways, changing the gear ratio on the secondary cog set (3). The floating derailleur pulley is a fundamental part of the chain puller.

CHAIN TENSIONER. According to the previous description, on the front side of the right and left derailleur cages (25) (26), there are two carved slots (23) that drive the floating pulley (22) where the primary roller chain (8) runs on. Two springs (35) are fixed between the lower edge of the slots (23) and the hub (24) of the floating pulley (22) so as to ensure the tension of the primary chain, with the aim of compensating the difference of the cog diameter during the gear change.

DERALLIEUR BODY. According to the above mentioned invention, the derailleur body (27) supports the principal elements of its mechanism; there are the two precision bushings (29) on it, by means of which it moves (A) onto the upper and lower slides (37) (38), eliminating any slacks that can cause damage during gear change. In the middle of the body, between the bushings, placed on top of the another, there is a slot (28) for the gear cable (45) which is fixed on the rear of the body with a cable fixing bolt (34). The precision bushings (29), lean towards the upper and lower slides (37) (38) so as to have the derailleur on the same line of the bicycle axis (64) when it shifts (A) for the change of gears.

UPPER AND LOWER SLIDES. Completely according to the previous description, the derailleur body runs on two steel slides, an upper and a lower one (37) (38), obtained from two refaced tubes, which are laid one over the other and are parallel to the horizontal plain and lean so much so that the derailleur (1) is always in line to the bicycle axis (64) maintaining the floating pulley (22) and the right and left side rollers (30) (31), that shift the primary roller chain (8), always at the proper distance from the cogs.

RIGHT AND LEFT SLIDE BOXES. According to the previous description, the slide boxes (39) (40) are firmly fixed to the right and left side of the gear-box plates (57) (58), and three gear cable pulleys (43) are also fixed on them with the axles (44), that make the gear cables (45) move back and forth; the extremities of the upper and lower slides (37) (38) are housed in four dead holes, two on the right side and the other two on the left side of the right and left slide boxes (39) (40).

DERAILLEUR TRAVEL ADJUSTER. Completely agreeing with the previous description, the left and the right side travel adjusters (41) (42) allow the adjustment of the derailleur (1); the two adjusters are fixed into two holes on the right and on the left side of gear-box plates (57) (58).

PRIMARY AND SECONDARY AXLES. Completely agreeing to the invention previously described, the primary axle starts its motion from the crank-arm (12) positioned in the crank-arms (13) that holds the primary cog set (2) assembled on the fitting in the centre of the axle where it is fixed through a cog set lock-nut (7). On the primary cog set sides, there are the bearing (11) seats on the axle. The secondary axle (10) starts its motion from the primary looping ring roller chain (8) and holds the secondary cog set (3) assembled on the fitting in the central zone and fixed with a lock-nut (7). On the right side of the secondary axle there is the fitting for the outboard chain ring (15) of the secondary transmission; on the secondary cog set sides there are the bearing (11) seats on the axle. At the ends of both the hollow axis, there are the fittings (14) for the crank-arm fixing bolt and for the outboard chain ring (15).

SECONDARY TRANSMISSION. Completely agreeing with the previous description, the secondary transmission is composed of the outboard chain ring (15), the secondary roller chain (17) and the rear cog (18) positioned on the rear wheel of the bicycle (63). Both the diameter of cogs and the teeth of the secondary transmission can be freely changed according to the bikers' purposes.

GEAR SELECTOR. As completely agreed with the description of the above-mentioned invention, the gear selector (47) stops the derailleur exactly on the gear chosen by the user; besides, a click is heard, indicating that a new gear is engaged. The selector is composed of two parallel slides (50) with a spacing (48) for each gear. The gear selector slider runs (49) between the slides (50) that when it is shifted on the spacing (48), causes a click. The gear cable (45) is fixed to the selector with a fixing bolt (51) that moves together with the derailleur (1). The selector is adjustable in order to have a perfect balance of the derailleur near the cog sets.

TWIST SHIFTER. In fully agreement with the previous description, the twist shifter (53) positioned on the handle bar, by means of a cable gear (45) and two back and forth sheaths (46) linked to the derailleur (1) that, running on (A) the upper and lower slides (37) (38) engages the gears. On the twist shifter (53) we can read the corresponding number of gears and we can also find the cable tension adjusters. The gear cable (45) is closed as a ring into the twist shifter (53) and is attached to its ends with two screw clamps.

GEAR CABLE PULLEYS. Fully agreed with the previous description, three small pulleys (43) drive the gear steel cable (45) inside the gear box so that the derailleur moves from right to left, without using a return spring. The pulleys are assembled on two axles (44) and vertically assembled in the housing holders of the derailleur runner slides. The cables are protected with usual bicycles housings (46).

GEAR BOX. Completely agreeing with the previous description, the gear box of this invention, can be easily dismantled, varied and adjusted for a possible installation on different types of bicycle frames. The gear box can generally, be made in two aluminium plates, spaced in a parallel way on the right and left side (57) (58), supporting all the mechanic devices. Between the plates, there are the bearing seats (11), the holes for the primary and secondary axles, the seats, supporting the upper and lower slide boxes the holes for the left and right side travel adjuster and the frame gear box fixing. The second part of the gear box is made of plastic, and is realized, in order to ensure the perfect closing of the open spaces between the two plates (57) (58) and is composed of the upper and lower part (60) (61) that can be easily dismantled; on the lower part there is a maintaining cover (62).

ANTI CHAIN-SUCK. In perfect agreement with the previous description, the anti chain-suck (54) prevents the primary roller chain to get stuck to the teeth of the primary cog set, thus hitting and damaging the derailleur. The anti chain-suck device is made of hard steel and is located between the primary axle and the derailleur (1) rear side.

NUMBER OF GEARS. For a better explanation of this invention, each cog of the cog set is interchangeable so as to obtain different useful gear ratios whose numbers can vary and determine the number of gears available, as for example: seven for the downhill, eight or nine for the city bikes and eleven for the cross country. The primary and secondary cog sets, both of them rotating, have always the same number of cogs. In the present drawings, the version with nine gears has been chosen just for its major simplicity of the diagram.

### INDUSTRIAL APPLICABILITY

The Derailleur Case For Bicycles, which is light and of a small dimension, is particularly suitable in the cycling field, especially for mountain bikes, because it can be assembled inside a boxed frame, or in a small box protecting it from mud and dust. Considering the versatility of this transmission system, it enables a mountain bike to vary the ratio gears of the secondary transmission, simply by changing the diameter of the cog set on the rear wheel hub. The Derailleur Case For Bicycles is suitable for all kinds of bicycle frames, including downhill and free ride frames, and for all cycling disciplines. For its use in the industrial field, we have a multiplier and revolution reducer with more gears: nine, ten or more, because its number is limited to the available space.

1-26. (canceled)

27. A Transmission Case For Bicycles, comprising a secondary axle (10) supporting a secondary cog set (3) and a chain ring (15), disposed outside the derailleur case and connectable to a rear wheel of the bicycle by means of a secondary roller chain (17), a primary axle (9) of the crankshaft supporting at least a primary cog linked to the secondary cog set (3) by means of a primary looping ring roller chain (8), wherein primary and secondary axles are parallel, and further comprising a derailleur (1) externally operated, characterized by the fact that there is provided a plurality of primary cogs defining a primary cog set (2) wherein the cogs have different diameters, and are arranged in inverse order with respect to each other, in such a manner that the maximum diameter cog (5) of the primary cog set (2) corresponds to minimum diameter cog (6) of the secondary cog set (3) and by the fact that the derailleur (1) is positioned between primary and secondary cog sets (2) (3) and adapted to shift a primary looping ring roller chain (8) on the cog sets (2) (3), for performing a gear change.

28. A Transmission Case For Bicycles, according to claim 27, wherein there are provided upper and lower slides (37), (38) that are arranged diagonally with respect to the derailleur (1) and with respect to the longitudinal bicycle axis (64), wherein the derailleur (1), is adapted to slide on said slides (37), (38) whereby the looping ring roller chain shifts on both cog sets (2), (3).

29. A Transmission Case For Bicycles, according to claim 27, wherein, the rotating secondary cog set (3) is composed of single cogs separated by cog spacers (4); all this unit has a cone shaped frustum with its small diameter cog (6) on the left referring to the bicycle axis (64); the secondary cog set (3) starts its motion from the primary looping ring roller chain (8).

30. A Transmission Case For Bicycles, according to claim 28, wherein, the derailleur devices that brings into effect the changing of gear rotations of the primary looping ring roller chain (8) on the primary cog set (2) are the right roller (30) and the left roller (31), which, by pushing to primary roller chain (8) makes it possible to engage the higher end lower gears.

31. A Transmission Case For Bicycles, according to claim 28, wherein the derailleur device which brings into effect the gear changing of the primary looping ring roller chain (8) on the secondary cog set (3) is the floating pulley (22) on which the primary roller chain (8) runs wherein the floating pulley (22) is between the right and the left side cages (25) (26) of the derailleur.

32. A Transmission Case For Bicycles, according to claim 28, wherein the non-floating pulley (19) is the derailleur (1) device that drives the primary roller chain (8) out of the primary cog set (2), which is assembled on the upper side between the left and right side of the derailleur cages exactly between the primary cog set (2) and the floating pulley (22); it is possible to adjust the primary looping ring roller chain (8) tension by shifting the floating pulley on the proper slot (21) and fixing it with the proper with the fixing bolt (20), as soon as the adjustment is finished, so as to compensate the natural primary chain straighten (8) due to its constant use.

33. A Transmission Case For Bicycles, according to claim 28, wherein the springs (35) of the chain pulley (22), between the lower side of the right and left side cages (25) (26), and the floating pulley (22) which runs on two carved slots (23) on the cages maintain the tension of the primary chain during the gear changing; the floating pulley (22) has a double function: to move the primary roller chain (8) onto the secondary cog set (3) and to keep it in tension.

34. A Transmission Case For Bicycles, according to claim 28, wherein the main elements of the derailleur (1) are fixed to the derailleur body (27) where the bushings (29) are inserted, by means of which, the derailleur body (27) shifts (A) on the upper and lower slides (37) (38) in an inclined position so that the derailleur is parallel to the bicycle axis (64), wherein the twist shifter cable (45) with the cable bolt (34), the right and left side cages (25) (26), the right and left side roller axles (32) (33), between the two bushings (29) in the derailleur body (27) there is a slot (28) for the gear cable (45) are fixed to the derailleur body (27).

35. A Transmission Case For Bicycles, according to claim 28, wherein, the derailleur (1) shifts (A) on both upper and lower slides (37) (38), made of two refaced steel tubes, lying on the top of the other and parallel to the horizontal plain, and inclined towards the bicycle axis (64) so as to maintain the derailleur (1), the floating pulley (22) and the left and right side rollers (30) (31) always at the same distance from the cogs.

36. A Transmission Case For Bicycles, according to claim 28, wherein, the gear selector (47) is located on the front side of the gear box to the left so that the derailleur (1) corresponds to the single cogs of the chosen gear; the gear selector (47) is composed of two parallel ways (50) provided with spacers (48) and a slider (49) fixed to the gear cable (45) by means of a fixing bolt (51); the slider (49) shifts on the spacers (48) and gives the biker the sensation of the gear change by the click on the twist shifter (53).

37. A Transmission Case For Bicycles, according claim 27, wherein, there is an anti chain-suck (54) device in the gear box that prevents the primary roller chain (8) from the damage of the derailleur (1) in case the chain is embedded in the primary cog set (2) and dragged inside it; the anti-suck (54) device is composed of an aluminium plate shaped in a way so that the primary roller chain has not enough space to be in contact with the derailleur.
